(19) United States
(12) Patent Application Publication
(10) Pub. No.: US 2022/0398517 A1
(43) Pub. Date: Dec. 15, 2022

(54) MOVING PARKING AND SUBSCRIPTION SERVICES FOR MOBILITY AS A SERVICE

(71) Applicant: International Business Machines Corporation, Armonk, NY (US)

(72) Inventors: Takeshi Watanabe, Kawasaki (JP); Yohkichi Sasatani, Yokohama (JP); Sanehiro Furuichi, Setagaya-ku (JP)

(21) Appl. No.: 17/346,426

(22) Filed: Jun. 14, 2021

(51) Int. Cl. G06Q 10/06; G06Q 50/30; G06Q 10/00; G06Q 50/06; G06N 3/08; G06N 20/10

(52) U.S. Cl. CPC G06Q 10/06313; G06Q 50/30; G06Q 10/20; G06Q 50/06; G06N 3/08; G06N 20/10; G06Q 20/127

(57) ABSTRACT

Providing moving parking and subscription services across a network by obtaining service information corresponding to a vehicle of a user, wherein the service information includes parking services and subscription services, obtaining vehicle information corresponding to one or more service vehicles, selecting a service vehicle of the one or more service vehicles, wherein the service vehicle accommodates one or more services for the vehicle of the user based at least in part on the service information, and determining a suitable set of conditions for the service vehicle to accommodate the one or more services for the vehicle of the user.

### BACKGROUND

The disclosure relates generally to computing systems. The disclosure relates particularly to providing moving parking and subscription services.

In today's interconnected and complex society, computers and computer-driven equipment are more commonplace. Processing devices, with the advent and further miniaturization of integrated circuits, have made it possible to be integrated into a wide variety of personal, business, health, home, education, entertainment, travel, and other devices. Accordingly, the use of computers, network appliances, and similar data processing devices continue to proliferate throughout society. For example, vehicles of every kind, size, and energy consumption are prevalent in every aspect of today's society, as people are more mobile today than likely at any time in recorded history. With respect to CASE (Connected, Autonomous, Shared & Services, Electric) and mobility as a service (MaaS), demand to effectively utilize autonomous cars, electric vehicles, and ordinary vehicles in securing temporary parking spaces for timely parking, ride sharing, and various other effective uses of a vehicle while parked are expected to be in high.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable providing moving parking and subscription services.

Aspects of the invention disclose methods, systems and computer readable media associated with providing moving parking and subscription services across a network by obtaining service information corresponding to a vehicle of a user, wherein the service information includes parking services and subscription services, obtaining vehicle information corresponding to one or more service vehicles, selecting a service vehicle of the one or more service vehicles, wherein the service vehicle accommodates one or more services for the vehicle of the user based at least in part on the service information, and determining a suitable set of conditions for the service vehicle to accommodate the one or more services for the vehicle of the user.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Embodiments of the present invention recognize that challenges exist in identifying locations and availability of parking spaces for vehicles due to the restricted and fixed nature of parking areas (e.g., designated on the road, parking lots on a premise, etc.). Additionally, in the absence of conventional solutions such as a valet service, drivers cannot park and leave vehicles at various places and/or times unattended. Furthermore, parked vehicles are at a standstill and therefore not used effectively in terms of space or as an information technology (IT) asset, resulting in a great social loss. Disclosed embodiments of the invention enable a flexible parking system where parking locations are not fixed by utilizing autonomous vehicles as designated parking areas. Additionally, providing optimum services for a parked vehicle by collecting and analyzing vehicle information of connected vehicles. Additional embodiments enable optimization for providing services by consolidating parked vehicles into groups based on types of services and parking time for reloading parked vehicles in the autonomous vehicles.

In an embodiment, one or more components of the system can employ hardware and/or software to solve problems that are highly technical in nature (e.g., predicting parking demand of vehicle users for parking areas, providing optimum services for a parked vehicle by collecting and analyzing vehicle information of connected vehicles, etc.). These solutions are not abstract and cannot be performed as a set of mental acts by a human due to the processing capabilities needed to facilitate providing optimum services for a parked vehicle by collecting and analyzing vehicle information of connected vehicles, for example. Further, some of the processes performed may be performed by a specialized computer for carrying out defined tasks related to predicting parking demand of vehicle users for parking areas. For example, a specialized computer can be employed to carry out tasks related to predicting parking demand of vehicle users for parking areas or the like.

Implementation of embodiments of the invention may take a variety of forms, and exemplary implementation details are discussed subsequently with reference to the Figures.

In an embodiment, a system executing the moving parking and subscription services method obtains service information of a vehicle of a user. For each vehicle (e.g., self-driving, human-driving, etc.) a user registers for vehicle services (e.g., parking services), the method receives user vehicle information, user information, and/or registration of subscription services. The user vehicle information can include information such as location of a vehicle (e.g., GPS, inside/outside service area, etc.), status of use (e.g., in use, on call, in parking, etc.), battery level (e.g., charge threshold), electricity cost, intended time/place to park, intended return time, intended place of return, etc. The user information can include information such as username, personal information including age, historically used vehicles, historically used subscriptions, etc. The subscriptions services (e.g., incidental services) that a user can register for or that the method provides can include external services (e.g., vehicle inspection, vehicle cleaning, vehicle battery charging, vehicle sharing, etc.) and vehicle provided as a device (e.g., computing grid service, energy grid service, car sharing service, etc.). In this embodiment, user vehicle information, user information, and/or registration of subscription services is provided by the user or user vehicle with consent of the user and used for the disclosed method with the consent of the user. The user vehicle information, user information, and/or registration of subscription services (e.g., registration information) may be provided to the system executing the method by users (e.g., during registration) or collected by a data processor and/or data controller and provided to the system for use by the method as set of services data associated with users.

The method trains a first machine learning model such as a recurrent neural network (RNN), support vector machine (SVM), or other classification machine learning model architecture, to predict parking demand for a designated parking area. The method trains the model to correctly predict parking demand by a user of a vehicle. In an embodiment, the method labels a set of user vehicle information that include features corresponding to intended time/place to park of a plurality of vehicles and provides the labelled set of user vehicle information for training the machine learning model. In an embodiment, the method reserves a portion of the labelled set of user vehicle information data for use as test data to validate the trained machine learning model. The trained machine learning model enables the prediction of parking demand for a designated parking area using new unlabeled registration information of a user. The trained model provides an output that indicates the demand for parking by the trained model from the new input user registration information. The demand for parking is determined by the method according to the trained model's output. In some instances, the method also trains the first machine learning model to predict an amount of use of the vehicle of the user. For example, if a vehicle of a user is in use (e.g., in use status), then the method utilizes a first machine learning model to predict use (e.g., amount of travel) of the vehicle using a location of a destination of the vehicle. Alternatively, the method can utilize the first machine learning model to predict use (e.g., amount of travel) of the vehicle using a trajectory pattern (e.g., historical use data, travel distance estimate for battery, etc.) of the vehicle. Additionally, the method can utilize a predicted use of the vehicle to predict a remaining charging of the vehicle and determine an electricity cost associated with providing charging services for the vehicle.

In an embodiment, the method assigns a service urgency to a vehicle of a user. In this embodiment, the method determines the service urgency of the vehicle of the user using user vehicle information. For example, if the method determines that a battery level of an autonomous vehicle is low (e.g., below a threshold level) and is near (e.g., within a threshold time frame, days, months, etc.) an inspection deadline, then the method may assign the autonomous vehicle a “high urgency”. In another example, if the method determines that an autonomous vehicle is near (e.g., within a threshold time frame, days, months, etc.) an inspection deadline, then the method may assign the autonomous vehicle a “medium urgency”. In another example, if the method determines that a battery level of an autonomous vehicle is high (e.g., above a charging requirement threshold level) and requires an inspection, then the method may assign the autonomous vehicle a “medium urgency”. In yet another example, if the method determines that an autonomous vehicle is within an executable period of a periodic service (e.g., vehicle inspection, etc.), then the method may assign the autonomous vehicle a “low urgency”.

In an embodiment, the method determines service constraints for subscription services of a vehicle of a user. In this embodiment, the method utilizes user vehicle information (e.g., intended time/place to return), registration of subscription services, and/or status information (e.g., congestion state, charging volume, etc.) of subscription services to determine an amount time required (e.g., service constraint) to provide a subscription service.

In an embodiment, the method obtains vehicle information of a service vehicle. For each service vehicle (e.g., self-driving, human-driving, etc.) the method receives service vehicle information. The service vehicle information can include information such as location of a service vehicle, provided subscription services, number of loadable vehicles, etc. In this embodiment, the service vehicle information can be provided to the system executing the method by periodically (e.g., during taxi) by service vehicles or collected in response to a query of the method for use as set of service vehicle data associated with one or more service vehicles. In another embodiment, the method deploys one or more service vehicles to a location corresponding to a designated parking area based on a determined demand for parking services (e.g., output of first of the first machine learning model, volume of received request, etc.) the designated parking area.

In an embodiment, the method identifies candidate service vehicles of one or more service vehicles the method deploys to a location corresponding to a designated parking area based on availability of the candidate service vehicles. The availability of the candidate service vehicles may depend on an urgency status of the candidate service vehicle. For example, a service vehicle with a high urgency is set for immediate allocation by the method. In another example, a service vehicle with a medium urgency is assigned an “on call” status until three (3) vehicles can be serviced by the service vehicle. In yet another example, a service vehicle with a low urgency is assigned an “on call” status until six (6) vehicles can be serviced by the service vehicle. In this embodiment, the method selects a candidate service vehicle to execute and/or accommodate a registered vehicle service of the user using service information (e.g., service type, time/place of return, etc.) corresponding to the registered vehicle service of the user.

The method transmits an acceptance request to a computing device of user. The method transmits a service acceptance request to a computing device of a user via Transmission Control Protocol (TCP) and the Internet Protocol (IP). The service acceptance request includes moving parking and subscription services of the user. In this embodiment, the method receives a user response (e.g., acceptance or denial) to the service acceptance request. In one scenario, if the method determines that the user response to the service acceptance request is a “denial” by the user, then the method continues to identify candidate service vehicles to provide the registered vehicle service of the user. In another scenario, if the method determines that the user response to the service acceptance request is an “acceptance” by the user, then the method allocates the selected candidate service vehicle to provide the registered vehicle service of the user.

In an embodiment, the method determines a suitable set of conditions for a service vehicle to accommodate a vehicle of user with respect to the accepted moving parking and subscription services. The method selects one or more user vehicles with the same service urgency. For example, the method utilizes user vehicle information (e.g., intended location and/or time to return, intended location and/or time of service, etc.) to select user vehicles within one or more distance and/or temporal thresholds with the same service urgency. In this example, the method can modify the distance and/or temporal thresholds of the one or more user vehicles using vehicle information (e.g., battery remainder, location of vehicle, computing resources, etc.) to optimize use of resources of the user vehicles, which reduce travel time of the service vehicles and optimize pick up routes of service vehicles accommodating user vehicles (i.e., the method selects vehicle with the proximate park/return locations and times).

In this embodiment, the method modifies parking locations and corresponding time slots for parking for the selected user vehicles. The method receives available parking space information that includes on-street and parking services and identifies an available parking space (e.g., designated location) proximate to a location of a requested parking services of user vehicles. In one example, the method can determine a route, which can include a path to traverse to arrive a designated time, for one or more service vehicles to a location (e.g., designated location) of a selected user vehicle using positional information (e.g., GPS) of service vehicles and user vehicles. In this example, if the method determines that either service vehicle or the user vehicle is self-driving, then the method provides move instructions (e.g., routes) to the service vehicle or the user vehicle to move to a designated location (e.g., parking spot, central location, etc.) at a designated time to reduce idle time due to queueing, which may be determined based on user vehicle information and service vehicle information such as charge remaining, number of loadable vehicles, service constraints, etc.

In this embodiment, the method determines a load and/or unload order of the selected user vehicles. The method can determine a type of service a service vehicle provides using service vehicle information as well as a type of services requested for selected user vehicles using registration of subscription services. In this embodiment, the method can group the selected vehicles based on factors including but not limited to service type, service operation time, service urgency, user vehicle information, routes, etc. Additionally, the method determines an order of loading or unloading of user vehicles with respect to a service vehicle according to group assignments of the user vehicles.

In an alternative embodiment, the method modifies a load combination of one or more service vehicles with an “in use” status due to detection of a change in status (e.g., complete, pending, etc.) of a service for a user vehicle. In this embodiment, the method utilizes positional information of the one or more service vehicles to identify or designate a reloading base (e.g., exclusive facility, temporary use of a road, etc.) to re-group vehicles based on factors such as but not limited to subscription services type, return areas, time constraints etc. Furthermore, the method modifies routes of service vehicles that require updated load combinations. In an example embodiment, the method determines a load combination of one or more service vehicles based upon leveling the volume of power supply of container cars to equalize power supply time utilizing the remaining battery capacity of selected user vehicles (i.e., ensuring that each service vehicle that provides battery charging service is loaded with user vehicles that require similar charging amounts). Additionally, the method can solve the problem of optimization of a combination by prioritizing time to return and minimizing the travel distance of service vehicles by using, as parameters, locations of vehicles, electricity cost, and time/places to return. Furthermore, the method may utilize a quantum computer for high-speed processing of the combination optimization problem.

In an embodiment, the method provides subscribed services of a registration of subscription services by a user. In this embodiment, the method provides a service vehicle with a route to a service base that provides a subscription service to a user vehicle. For example, the method delivers a user vehicle to the service base as a vehicle provided as a device (e.g., computing grid service, energy grid service, car sharing service, etc.). In this example, the method transmits a reward for service from the service receiver (e.g., service base, ride share recipient, etc.) In an alternative embodiment, the method provides a service vehicle with instructions to provide a subscription service to a user vehicle while in transit. In this embodiment, the method instructs the service vehicle to return the user vehicle to a designated location. Alternatively, if the method determines that the user vehicle is a self-driving vehicle, then the method transmits move instructions to the user vehicle to return via a designated route to a designated return location. In another embodiment, the method transmits move instructions to a service vehicle, which can include one or more service palettes that provide subscriptions services, that correspond to a location of a user vehicle that requires a subscription service provided by the service vehicle.

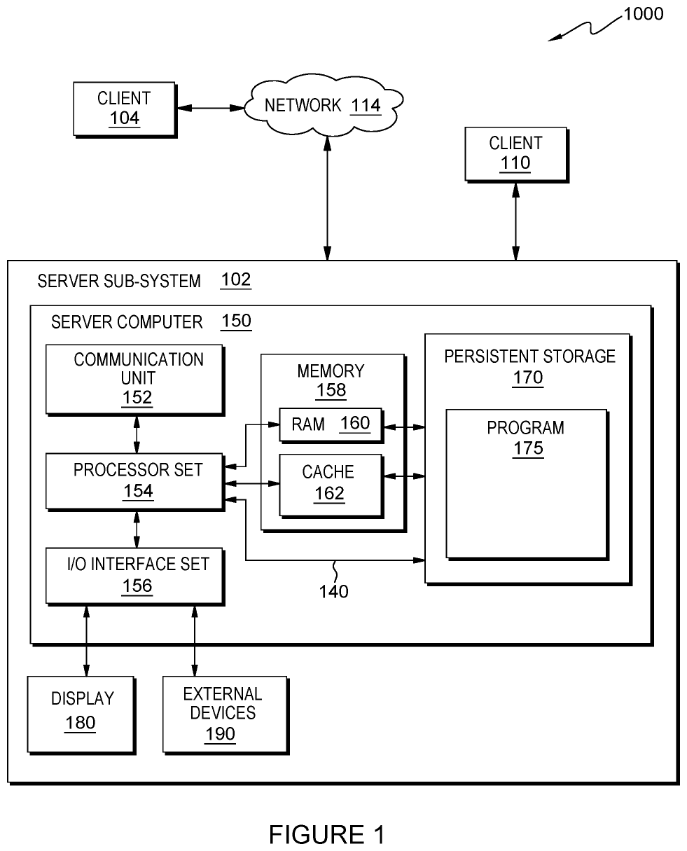

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise application program (not shown) together with sufficient computing resource (processor, memory, network communications hardware) to execute the program.

As shown in FIG. 1, server sub-system 102 comprises a server computer 150. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment may be made by those skilled in the art without departing from the scope of the invention as recited by the claims.

The present invention may contain various accessible data sources, such as client device 104 or client device 110, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 175 enables the authorized and secure processing of personal data. Program 175 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Program 175 provides information regarding personal data and the nature (e.g., type, scope, purpose, duration, etc.) of the processing. Program 175 provides the user with copies of stored personal data. Program 175 allows the correction or completion of incorrect or incomplete personal data. Program 175 allows the immediate deletion of personal data.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., service program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., service program 175 on server computer 150, can be stored on such portable computer readable storage media and can be loaded onto persistent storage 170 via I/O interface(s) 156. I/O interface(s) 156 also connect to a display 180.

Display 180 provides a mechanism to display data to a user and may be, for example, a computer monitor. Display 180 can also function as a touch screen, such as a display of a tablet computer.

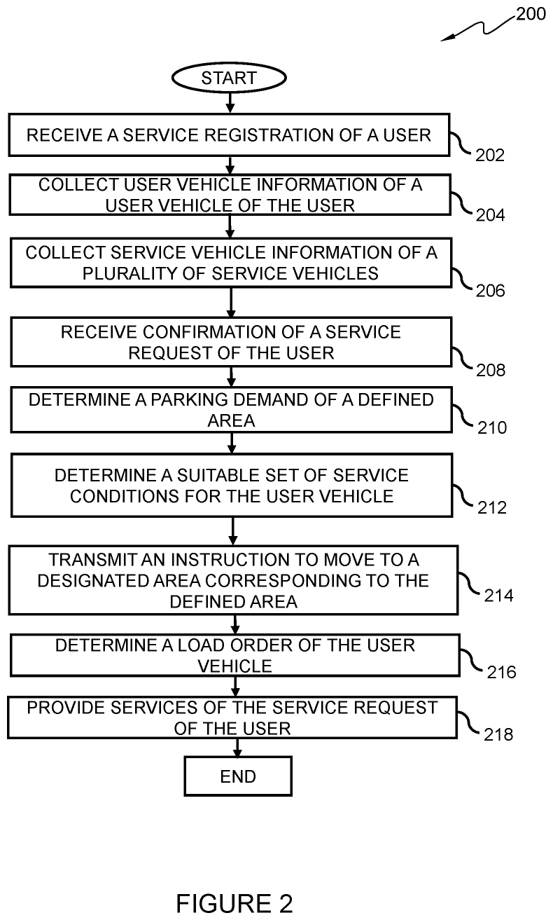

FIG. 2 provides a flowchart 200, illustrating exemplary activities associated with the practice of the disclosure. In one embodiment, service program 175 initiates in response to a user connecting client device 104 or client device 110 to service program 175 through network 114. For example, service program 175 initiates in response to a user registering (e.g., opting-in) a vehicle (e.g., client device 104) with service program 175 via a WLAN (e.g., network 114).

After program start, at block 202, the method of service program 175 receives a service registration of a user. In an embodiment, the method obtains service information corresponding to a vehicle of a user from a service registration of the user, wherein the service information includes parking services and subscription services. In this embodiment, the subscription services include services such as a vehicle inspection service, a cleaning service, a charging service, a car sharing service, participation in a computer grid, participation in an energy grid, etc.

At block 204, the method of service program 175 collects user vehicle information of a user vehicle of the user. In an embodiment, the method collects sensor data (e.g., battery levels, charge thresholds, positional data, etc.) of one or more sensors of the vehicle of the user.

At block 206, the method of service program 175 collects service vehicle information of one or more service vehicles. In an embodiment, the method obtains vehicle information corresponding to one or more service vehicles. In this embodiment, the method collects sensor data (e.g., battery levels, charge thresholds, positional data, etc.) of one or more sensors of the one or more service vehicles.

At block 208, the method of service program 175 receives confirmation of a service request of the user. In an embodiment, the method receives an acceptance of a service recommendation based on a service registration of a user.

At block 210, the method of service program 175 determines a parking demand of a defined area. In an embodiment, the method utilizes a machine learning model to predict demand for parking services at a parking location. In this embodiment, the method selects a service vehicle of the one or more service vehicles, wherein the service vehicle accommodates one or more services for the vehicle of the user based at least in part on the service information.

At block 212, the method of service program 175 determines a suitable set of service conditions for the user vehicle. In an embodiment, the method determines a suitable set of conditions for the service vehicle to accommodate the one or more services for the vehicle of the user. In this embodiment, the method identifies user vehicle information and respective subscription services of two or more vehicles of respective users.

The method determines a respective destination of two or more service vehicles based at least in part on past demand for parking services respective parking services type of the two or more vehicles of respective users based at least in part on user vehicle information of the two or more vehicles of the respective users, wherein the user vehicle information indicates service urgency of the two or more vehicles of the respective users. Additionally, the method identifies respective service times of the two or more vehicles of the respective users. Also, the method determines a set of conditions that includes a suitable time and a suitable location to load a vehicle of the two or more vehicles into a service vehicle.

At block 214, the method of service program 175 transmits an instruction to move to a designated area corresponding to the defined area. In an embodiment, the method provides the service vehicle with instructions to move to a destination of the set of conditions, wherein the set of conditions includes a suitable time and a suitable location to load the vehicle. In this embodiment, the method can provide the vehicle with instructions to move to a destination of the set of conditions, wherein the set of conditions includes a suitable time and a suitable location for loading by the service vehicle.

At block 216, the method of service program 175 determines a load order of the user vehicle. In an embodiment, the method determines a load combination of the two or more user vehicles for the service vehicle based at least in part on the respective subscription services of the two or more vehicles and the user vehicle information of the two or more vehicles. In this embodiment, the method groups the two or more user vehicles for the two or more service vehicles based at least in part on the parking services of the two or more vehicles of the respective users and the user vehicle information of the two or more vehicles of the respective users.

At block 218, the method of service program 175 provides services of the service request of the user. In an embodiment, the method instructs a service vehicle to deliver one or more vehicles of users to a service station to provide a registered service to the one or more vehicles. In another embodiment, the method instructs a service vehicle to provide a registered service to one or more vehicles of users.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Mobility as a service (MaaS): the capability provided to the consumer is to make transportation more efficient and simple. MaaS aims to integrate all aspects of customer journeys into a single, user-friendly service or application. For example, this may include trip planning, booking, ticketing, payment, and updates. The consumer does not manage or control the underlying cloud infrastructure including network, servers, operating systems, storage, or even individual application capabilities, with the possible exception of limited user-specific application configuration settings.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

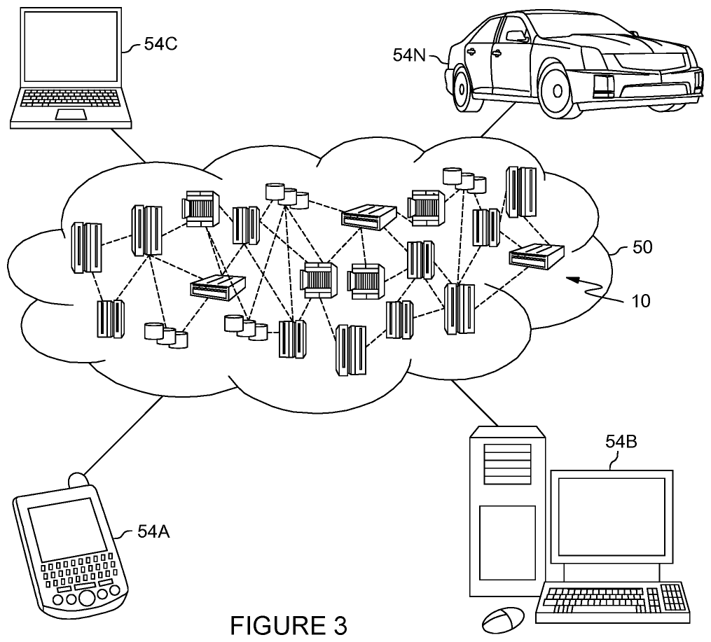

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

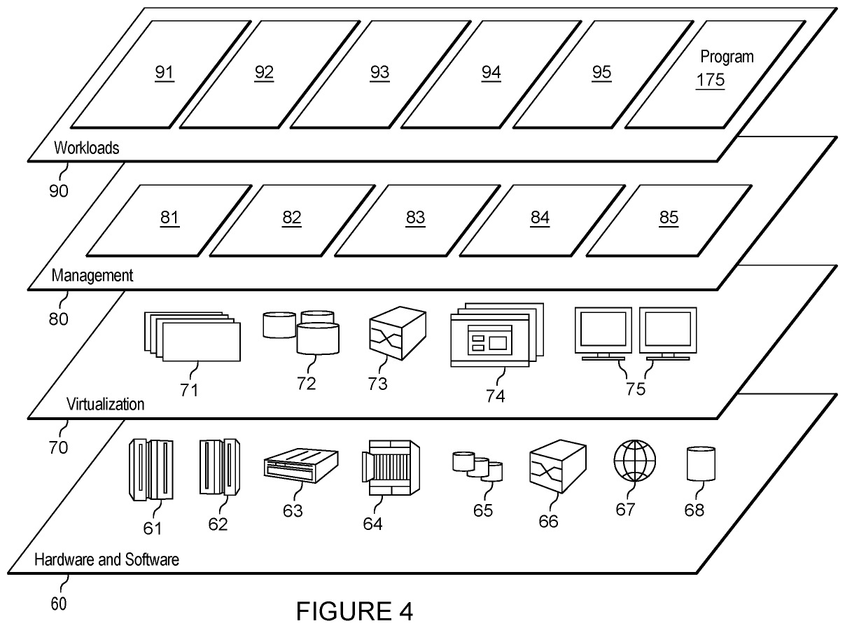

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and service program 175.

Service program 175 provides a parking service along with subscription services by instructing a service vehicle move to an available parking space based on a prediction of parking demand of user vehicles. User vehicles utilizing the service vehicle for parking can receive various kinds of prearranged subscription services (e.g., incidental services) such as cleaning, vehicle inspection, and charging. Service program 175 provides a mechanism to provide appropriate services during parking by analyzing information of user vehicles connected to the network. Service program 175 allows for providing valuable services to users, which are executed automatically by collecting and analyzing vehicle information (e.g., charging state of electrical vehicle (EV)).

In an example embodiment, service program 175 determine routes and/or allocation location of service vehicles based at least in part on past parking demand predictions. Service program 175 determines a pickup priority of at least one user vehicle based on service urgency (e.g., charging volume, deadline of periodic maintenance such as vehicle inspection, etc.). In this example embodiment, service program 175 groups user vehicles for loading into a service vehicle based at least in part on service constraints (e.g., service time, close place/time to park and return, etc.). Additionally, service program 175 modifies a load combination of user vehicles of two or more service vehicles. For example, service program 175 groups user vehicles according to subscription service type (e.g., car wash, vehicle inspection, and computing node) to reload user vehicles into service vehicles. In another example, service program 175 determines an order and combination of loaded vehicles based on vehicle information (e.g., state of charging, the required volume of power supply, etc.).

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method, the method comprising:
receiving, by one or more computer processors, vehicle information associated with a vehicle of a user from one or more onboard vehicle sensors;
receiving, by one or more computer processors, vehicle information associated with one or more service vehicles from one or more onboard service vehicle sensors;
predicting, by one or more computer processors, a parking demand within a predefined area of the vehicle using a trained machine learning model; and
routing, by one or more processors, at least one of the vehicle of the user or a service vehicle of the one or more services vehicles to a predetermined parking area at a predetermined time based, at least in part, on the predicted parking demand within the predefined area of the vehicle, the vehicle information associated with the vehicle of the user, and the vehicle information associated with the service vehicle.

2-3. (canceled)

4. The method of claim 1, further comprising determining a suitable set of conditions for the service vehicle to accommodate one or more services for the vehicle of the user based, at least in part, on:
identifying, by one or more computer processors, respective subscription services of vehicles of two or more users;
identifying, by one or more computer processors, user vehicle information of the vehicles of the two or more users; and
determining, by one or more computer processors, a load combination of the vehicles for the service vehicle based at least in part on the respective subscription services of the vehicles and the user vehicle information of the vehicles.

5. The method of claim 4, wherein determining the suitable set of conditions for the service vehicle to accommodate the one or more services for the vehicle of the user, further comprises:
determining, by one or more computer processors, a respective destination of two or more service vehicles based at least in part on past demand for parking services; and
determining, by one or more computer processors, respective parking services type of vehicles of two or more users based at least in part on user vehicle information of the vehicles of the two or more users, wherein the user vehicle information indicates service urgency of the vehicles of the two or more users.

6. The method of claim 5, further comprising:
identifying, by one or more computer processors, respective service times of the vehicles of the two or more users; and
grouping, by one or more computer processors, the vehicles of the two or more users for the two or more service vehicles based at least in part on the parking services of the vehicles of the two or more users and the user vehicle information of the vehicles of the two or more users.

7. The method of claim 5, wherein parking services are selected from a group consisting of: the service vehicle as a parking space and the service vehicle as a moving service; and
wherein subscription services are selected from a group consisting of: a vehicle inspection service, a cleaning service, a charging service, a car sharing service, participation in a computer grid, and participation in an energy grid.

8. A computer program product comprising one or more computer readable storage devices and collectively stored program instructions on the one or more computer readable storage devices, the stored program instructions comprising:
program instructions to receive vehicle information associated with a vehicle of a user from one or more onboard vehicle sensors;
program instructions to receive vehicle information associated with one or more service vehicles from one or more onboard service vehicle sensors;
program instructions to predict a parking demand within a predefined area of the vehicle using a trained machine learning model; and
program instructions to route at least one of the vehicle of the user or a service vehicle of the one or more services vehicles to a predetermined parking area at a predetermined time based, at least in part, on the predicted parking demand within the predefined area of the vehicle, the vehicle information associated with the vehicle of the user, and the vehicle information associated with the service vehicle.

9-10. (canceled)

11. The computer program product according to claim 8, further comprising program instructions to determine a suitable set of conditions for the service vehicle to accommodate one or more services for the vehicle of the user based, at least in part, on instructions to:
identify respective subscription services of vehicles of two or more users;
identify user vehicle information of the vehicles of the two or more users; and
determine a load combination of the vehicles for the service vehicle based at least in part on the respective subscription services of the vehicles and the user vehicle information of the vehicles.

12. The computer program product according to claim 11, wherein program instructions to determine the suitable set of conditions for the service vehicle to accommodate the one or more services for the vehicle of the user, further comprise program instructions to:
determine a respective destination of two or more service vehicles based at least in part on past demand for parking services; and
determine respective parking services type of vehicles of two or more users based at least in part on user vehicle information of the vehicles of the two or more users, wherein the user vehicle information indicates service urgency of the vehicles of the two or more users.

13. The computer program product according to claim 12, the stored program instructions further comprising:
program instructions to identify respective service times of the vehicles of the two or more users; and
program instructions to group the vehicles of the two or more users for the two or more service vehicles based at least in part on the parking services of the vehicles of the two or more users and the user vehicle information of the vehicles of the two or more users.

14. The computer program product according to claim 12, wherein parking services are selected from a group consisting of: the service vehicle as a parking space and the service vehicle as a moving service; and
wherein subscription services are selected from a group consisting of: a vehicle inspection service, a cleaning service, a charging service, a car sharing service, participation in a computer grid, and participation in an energy grid.

15. A computer system comprising:
one or more computer processors;
one or more computer readable storage devices; and
stored program instructions on the one or more computer readable storage devices for execution by the one or more computer processors, the stored program instructions comprising:
program instructions to receive vehicle information associated with a vehicle of a user from one or more onboard vehicle sensors;
program instructions to receive vehicle information associated with one or more service vehicles from one or more onboard service vehicle sensors;
program instructions to predict a parking demand within a predefined area of the vehicle using a trained machine learning model; and
program instructions to route at least one of the vehicle of the user or a service vehicle of the one or more services vehicles to a predetermined parking area at a predetermined time based, at least in part, on the predicted parking demand within the predefined area of the vehicle, the vehicle information associated with the vehicle of the user, and the vehicle information associated with the service vehicle.

16-17. (canceled)

18. The computer system according to claim 15, further comprising program instructions to determine a suitable set of conditions for the service vehicle to accommodate one or more services for the vehicle of the user based, at least in part, on instructions to:
identify respective subscription services of vehicles of two or more users;
identify user vehicle information of the vehicles of the two or more users; and
determine a load combination of the vehicles for the service vehicle based at least in part on the respective subscription services of the vehicles and the user vehicle information of the vehicles.

19. The computer system according to claim 15, wherein the program instructions to determine the suitable set of conditions for the service vehicle to accommodate the one or more services for the vehicle of the user further comprise program instructions to:
determine a respective destination of two or more service vehicles based at least in part on past demand for parking services; and
determine respective parking services type of vehicles of two or more users based at least in part on user vehicle information of the vehicles of the two or more users, wherein the user vehicle information indicates service urgency of the vehicles of the two or more users.

20. The computer system according to claim 19, the stored program instructions further comprising:
program instructions to identify respective service times of the vehicles of the two or more users; and
program instructions to group the vehicles of the two or more users for the two or more service vehicles based at least in part on the parking services of the vehicles of the two or more users and the user vehicle information of the vehicles of the two or more users.
